(19) United States
(12) Patent Application Publication
(10) Pub. No.: US 2022/0210963 A1
(43) Pub. Date: Jul. 7, 2022

(54) REDUCTION OF SHARE WEAR

(71) Applicant: Lemken Gmbh & Co KG, Alpen (DE)

(72) Inventors: Ludger Maas, Sonsbeck (DE); Georg Achten, Tonisvorst (DE)

(21) Appl. No.: 17/604,337

(22) PCT Filed: Apr. 15, 2020
(86) PCT No.: PCT/DE2020/100304

§ 371 Date: Oct. 15, 2021

(30) Foreign Application Priority Data
Apr. 15, 2019 (DE) 10 2019 205 436.9

(51) Int. Cl. A01B 35/18; A01B 35/06; A01B 35/16; A01B 35/24

(52) U.S. Cl. CPC A01B 35/18; A01B 35/24; A01B 35/16; A01B 35/06

(57) ABSTRACT

The present invention relates to a soil tillage implement having soil tillage tools in particular tine-type tools such as wing share cultivator tines or goosefoot share cultivator tines, and a centre longitudinal axis, wherein the soil tillage implement comprises a number n of soil tillage tools, which are arranged in one or more tool rows following one another in the working direction and oriented transversely to the working direction, and comprises a number s of disc tools which are arranged in one or more disc rows following one another in the working direction and oriented transversely to the working direction and located in the working direction in front of the soil tillage tools. The soil tillage tools comprise at least a first tool region and a second tool region and the first tool region, through its exposed arrangement, is subjected to greater wear than the second tool region. The invention furthermore relates to a method for producing such a soil tillage implement.

The present invention relates to a soil tillage implement having soil tillage tools, in particular tine-type tools such as wing share cultivator tines or goosefoot share cultivator tines, and a centre longitudinal axis, wherein the soil tillage implement comprises a number n of soil tillage tools which are arranged in one or more tool rows following one another in the working direction and which are oriented transversely to the working direction, and comprises a number s of disc tools, which are arranged in one or more disc rows following one another in the working direction and which are oriented transversely to the working direction and which are located in the working direction in front of the soil tillage tools. The soil tillage tools comprise at least a first tool region and a second tool region and the first tool region, because of its exposed arrangement, is subjected to greater wear than the second tool region. Furthermore, the invention relates to a method for producing such a soil tillage implement.

Generally, the present invention relates to a soil tillage implement which can be pulled over the ground with a tow bar behind a tractor in order to till the soil. The soil tillage tool in particular can be a cultivator, wherein the invention described in the following can also be applied to similar soil tillage implements, i.e. soil tillage implements having a similar structure and/or similar arrangement of soil tillage tools, for example ploughs. Here, the soil tillage tool is supported by a height-adjustable running gear which can also be employed for transporting the soil tillage implement in a transport position on public roads between different places of operation.

Mechanisms generally known for such soil tillage implements, for example traction boosters, with which the force or weight distribution between tractor and soil tillage implement can be adjusted or changed, folding mechanisms, by means of which a width of the soil tillage implement can be reduced to a value that is permissible for public roads, or increased to a value that is efficient for the soil tillage as well as additional tools such as levelling tools, rollers, flexible harrows and the like can be particularly advantageous in connection with the present invention. The invention is thus particularly suitable for soil tillage implements comprising the corresponding mechanisms.

From DE 20 2011 107 533 U1 and EP 2 589 282 A1 a soil tillage implement with wing share cultivator tines is known, in the case of which the individual cultivator tines are fastened to a three-row frame and are distributed over the frame area defined by the edge of the said frame. In the case of such wing share cultivators or similar soil tillage implements it is noticeable that the soil tillage tools, i.e. for example the wing share, do not wear evenly because they are subjected to uneven loads.

In the case of wing share cultivators or goosefoot share cultivators it has been shown that on the one hand the share tips of the share and on the other hand the wing ends of the share are subjected to particularly great wear while the edge of the share between the share tip and the respective wing end is subjected to less severe wear. Here, the share tips and wing ends are subjected to three and four times as great a wear as the edges of the share between the share tip and the wing ends. Thus, the share tips of the share and the wing ends of the share are subjected to greater wear than the rest of the share because of their exposed arrangement. In other words, the share tips and the wing ends are configured and arranged so that when using the share they are subjected to greater wear than the rest of the share.

Furthermore, cultivators and similar soil tillage implements are basically known in the case of which, for loosening up the soil, for example cultivator shares, hollow discs, cutting discs or similar disc tools are additionally employed in the working direction in front of the soil tillage tools. Conventionally, they serve among other things for preparing the soil for the tillage by the cultivator share in that for example plant remnants are loosened up or cleared. Here, the disc tools however are arranged largely independent of the following soil tillage tools.

Before this background an object of the present invention consists in providing a soil tillage implement of the above technical area by way of which the wear of the soil tillage tools becomes more even in order to increase the service life of the soil tillage tools as a whole and thus reduce the operating costs of the soil tillage implement.

This object is solved through a soil tillage implement according to Claim 1 and a soil tillage implement according to Claim 2 as well as a method for producing a soil tillage implement according to any one of the Claims 13 and 14. Advantageous further developments of the invention are obtained from the subclaims.

In a soil tillage implement according to the invention having a number n of soil tillage tools, wherein the soil tillage tools are in particular tine-type tools such as wing share cultivator tines or goosefoot share cultivator tines, the soil tillage tools are arranged in one or more tool rows following one another in the working direction and which are oriented transversely to the working direction. Furthermore, the soil tillage implement comprises a number s of disc tools which are arranged in one or more disc rows following one another in the working direction and which are oriented transversely to the working direction and are located in the working direction in front of the soil tillage tools. Each of the disc tools has an individual lateral disc distance from a centre longitudinal axis of the soil tillage implement. The disc distance in the present context always means the distance of the cutting region of the disc tool engaging in the soil to the centre longitudinal axis of the soil tillage implement.

Furthermore, the soil tillage tools comprise at least a first tool region and a second tool region, wherein the first tool region is configured and arranged so that during the usage of the soil tillage tool it is subjected to greater wear than the second tool region. In other words, the first tool region, because of its exposed arrangement, is subjected to greater wear than the second tool region. Here, the first tool region of each of the soil tillage tools has an individual first lateral tool distance or multiple individual first lateral tool distances from the centre longitudinal axis of the soil tillage implement and the second tool region of each of the soil tillage tools has an individual second lateral tool distance from the centre longitudinal axis of the soil tillage implement which deviates from the individual first tool distance.

This means that the first and second tool region, which can be individual or both also in multiple parts, can be defined for each individual soil tillage tool and there is a first tool distance for the first tool region for each individual soil tillage tool. When the first tool region is in multiple parts, there are obviously multiple first tool distances each corresponding to the individual tool subregions. Likewise, there is a second tool distance for the second tool region for each individual soil tillage tool. When the second tool region is in multiple parts there are in turn multiple second tool distances each corresponding to the individual tool subregions. Since the soil tillage tools have different distances from the centre longitudinal axis, the first and second tool distances for different soil tillage tools with different distances are also distinct.

According to the invention, the disc tools and the soil tillage tools are arranged in such a manner that each first tool region with the first lateral tool distance is assigned a disc tool with the lateral disc distance in such a manner that the first lateral tool distance is equal to the lateral disc distance. In other words, there is for each region of the soil tillage tool otherwise subjected to greater wear, for example the share tips and the wing ends of a wing share cultivator, a disc tool which has the same lateral distance from the centre longitudinal axis as the region otherwise subjected to greater wear.

Thus, the wear of the soil tillage tool on the first tool region, which would otherwise be subjected to greater wear, can be reduced by the disc tool. This is possible because the disc tool can loosen up the soil and thus diminishes its wearing effect. Since the wearing effect is locally reduced in those places which would otherwise lead to an increased wear of the soil tillage tools, the soil tillage tools are correspondingly subjected to more even and altogether also slower wear. This makes possible longer service lives and thus lower operating costs.

An alternatively defined soil tillage implement with soil tillage tools according to the invention, which can be in particular tine-type tools such as wing share cultivator tines or goosefoot share cultivator tines, comprises a number n of soil tillage tools which are arranged in one or more tool rows following one another in the working direction and oriented transversely to the working direction, and comprises a number s of disc tools, which are arranged in one or more disc rows following one another in the working direction and oriented transversely to the working direction, and which are located in the working direction in front of the soil tillage tools. The soil tillage tools comprise at least a first tool region and a second tool region and the first tool region is configured and arranged so that during the usage of the soil tillage tool it is subjected to greater wear than the second tool region. In other words, the first tool region, because of its exposed arrangement, is subjected to greater wear than the second tool region. According to the invention, the disc tools and the soil tillage tools are arranged in such a manner that each first tool region is assigned a disc tool in such a manner that the first tool region is arranged aligned in the working direction behind the disc tool.

The local assignment of disc tools to soil tillage tools is preferentially accompanied also by a numerical assignment of the disc tools to soil tillage tools and the first tool regions of these, in particular share tips and wing ends. The numerical assignment of the disc tools to the soil tillage tools is described in more depth during the further course of the application.

By way of this, the advantageous effects of the invention explained above are achieved.

Preferably, the soil tillage tools are wing share cultivator tines or goosefoot share cultivator tines which comprise a share tip and two wings each with a wing end, wherein the share tip and the two wing ends form the first tool region and the wings, i.e. relative to the wing ends an inner region of the wings, form the second tool region.

Thus, the disc tools and the wing share cultivator tines or goosefoot share cultivator tines are arranged in such a manner that each share tip and each wing end are assigned a disc tool in such a manner that the share tip or the wing end is arranged aligned in the working direction behind the disc tool. In other words, each share tip or each wing end is assigned a disc tool in such a manner that the lateral distances of share tip and wing end on the one hand and disc tool on the other end to the centre longitudinal axis are the same.

Such cultivator tines preferentially engage between 2 cm and 4 cm deep in the soil. The disc tools can preferentially engage between 2 cm and 8 cm, particularly preferably approximately 5 cm in the soil, wherein other values are also possible which in particular depend on the size of the cultivator tines or disc tools.

Preferably, the soil tillage tools overlap partially in the working direction, i.e. they are arranged in the working direction aligned one behind the other, wherein in particular the wing ends of the wing share cultivator tines or goosefoot share cultivator tines overlap one another in the working direction and wherein the region, in which the soil tillage tools overlap one another in the working direction, is part of the first tool region.

In this configuration of the soil tillage implement a single disc tool is sufficient for the overlapping region, i.e. the common first lateral tool distance of the soil tillage tools overlapping one another, in order to achieve the advantageous effect of the invention.

In a preferred embodiment, the soil tillage tools each comprise only one share tip which forms at least a part of the first tool region and preferentially lies in a symmetry plane of the soil tillage tool. In this preferred embodiment, the share tip is the only first tool region, while further parts of the soil tillage tool are less severely subjected to the wear. This is the case for example when only the share tip of a wing share cultivator tine or goosefoot share cultivator tine is subjected to particularly great wear but the wing ends, because of their overlapping or for other reasons are subjected to less severe wear than the share tip. This can also be caused because of the fact that the share tip has to additionally cut open the soil while the wing ends are not exposed to this load. Here, the number s of the disc tools is equal to the number n of the soil tillage tools. In other words, each soil tillage tool is assigned exactly one disc tool.

In a further alternative preferred embodiment, in which the soil tillage tools each comprise one or two wing share ends, which forms or form at least a part of the first tool region, the number s of the disc tools is in each case greater or smaller by one than the number n of the soil tillage tools. In this regard it should be noted the wing share ends in this preferred embodiment can be arranged in particular in a manner that two wing share ends always overlap one another in overlap regions, i.e. are arranged aligned in the working direction one behind the other. In this case, the overlap regions lie between the soil tillage tools and a disc tool is arranged between each pair of adjacent soil tillage tools. Then, a disc tool less than the number of the soil tillage tools is provided. Alternatively, a disc tool each can also be arranged between each pair of adjacent soil tillage tools and additionally with respect to the outermost soil tillage tools outside. Then, a disc tool more than the number of the soil tillage tools is provided.

In an alternative preferred embodiment, the number s of the disc tools in each case is greater or smaller by one than twice the number n of the soil tillage tools.

This numerical ratio between soil tillage tools and disc tools preferentially relates to a configuration of the soil tillage tools in the form of or similar to the wing share cultivator tines or goosefoot share cultivator tines, which comprise a share tip and two wings each with a wing end, wherein a disc tool each is assigned to the share tip and the wing ends. Here, too, the wing share ends in this preferred embodiment can be arranged in particular in a manner that two wing share ends always overlap one another in overlap regions, i.e. are arranged aligned in the working direction one behind the other. In this case, the overlap regions lie between the soil tillage tools and between each pair of adjacent soil tillage tools a disc tool is arranged. Then, since each share tip of the soil tillage tools can also be assigned a disc tool, a disc tool less than twice the number of the soil tillage tools is provided. Alternatively, a disc tool each can also be additionally arranged outside with respect to the outermost soil tillage tools. Then, a disc tool more than twice the number of the soil tillage tools is provided.

In this preferred embodiment, the number s of the disc tools is always uneven. Regardless of the number n of the soil tillage tools, the number of disc tools is uneven because it is always greater or smaller by one than twice the number n of the soil tillage tools, i.e. greater or smaller by one than a number that is always even.

According to an advantageous embodiment, the respective outermost disc tools and the directly adjacent disc tools have a throwing direction directed to the inside towards the centre longitudinal axis. In this way it is ensured that in particular during connecting runs, during which the tillage area directly adjoins the tillage area of a preceding tillage, uneven soil tillage without formation of larger earth dams can take place.

In a preferred embodiment, the soil tillage implement comprises a frame in order to arrange the soil tillage tools over a frame area and a running gear having at least one main wheel. Here, the running gear can also comprise multiple main wheels. In the present context, a main wheel or multiple main wheels is to mean in particular the wheel or the wheels which, in contrast to one or more support wheels, continuously absorb or absorbs a greater weight force while utilising the soil tillage implement.

Here, the running gear is arranged within the frame area in such a manner that with respect to the working direction in front of and preferably behind the running gear as well as to the left and right of the running gear at least one soil tillage tool is arranged. Thus, a particularly compact design of the soil tillage implement is achieved which results in a high level of manoeuvrability, in particular in the form of a small turning circle, which increases the efficiency of the work on the field among other things because it is possible at the end of the respective tillage strip to turn with less effort in order to till the adjacent tillage strip in the opposite direction.

In a preferred embodiment, the disc tools are hollow discs, by way of which the respective throwing direction is defined, wherein the throwing directions of hollow discs located one behind the other in the working direction are opposed to one another. The hollow discs are preferably set obliquely and thus function as clearing discs.

Through this configuration and arrangement of the disc tools as even as possible and at the same time efficient soil tillage by the disc tools can be achieved. A piling-up of earth at the wheels of the working width can be bypassed through the present preferred arrangement of the disc tools or at least diminished.

In a preferred embodiment, the same number of disc tools per row are arranged on both sides outside the centre longitudinal axis. This means that for example in the case of an uneven number of disc tools per row, disc tools can also be arranged centrally, i.e. on the centre longitudinal axis. With corresponding symmetrical arrangement of the soil tillage tools, this makes possible an efficient tillage of the soil free of side draft.

In a particularly preferred embodiment, some, for example eight, soil tillage tools are arranged on a middle frame segment and two or more thereof, preferentially three, soil tillage tools form a tool row lying furthest in the working direction in front of the running gear. Here, a plurality, preferentially at least ten, soil tillage tools each are arranged on a left lateral frame segment and on a right lateral frame segment. In a preferred embodiment, the selection and arrangement of the soil tillage tools is selected so that the soil tillage implement comprises at least 28 soil tillage tools. Further preferably, the lateral frame segments can each be folded relative to the middle frame segment by a folding axis running parallel to the working direction, in order to switch the soil tillage implement between a working position and a transport position, wherein preferably the running gear is arranged on the middle frame segment and wherein optionally support wheels are arranged on the lateral frame segments.

This particularly preferred embodiment of the invention makes possible a highly compact soil tillage implement with which an efficient and very even tillage of the soil is possible.

A method according to the invention for producing a soil tillage implement according to the above description is characterised in that the disc tools and the soil tillage tools are arranged in such a manner that each first tool region with the first lateral tool distance a disc tool with the lateral disc distance is assigned in such a manner that the first lateral tool distance is equal to the lateral disc distance.

An alternative method according to the invention for producing a soil tillage implement according to the above description is characterised in that the disc tools and the soil tillage tools are arranged in such a manner that each first tool region is assigned a disc tool in such a manner that the first tool region aligned in the working direction behind the disc tool.

By way of the specific arrangement of the disc tools in the manner according to the invention, a soil tillage implement can be produced by way of which the wear of the soil tillage tools becomes more even in order to increase the service life of the soil tillage tools as a whole and thus to reduce the operating costs of the soil tillage implement.

Further advantages and further developments of the invention are obtained from the following figure description and the totality of the claims.

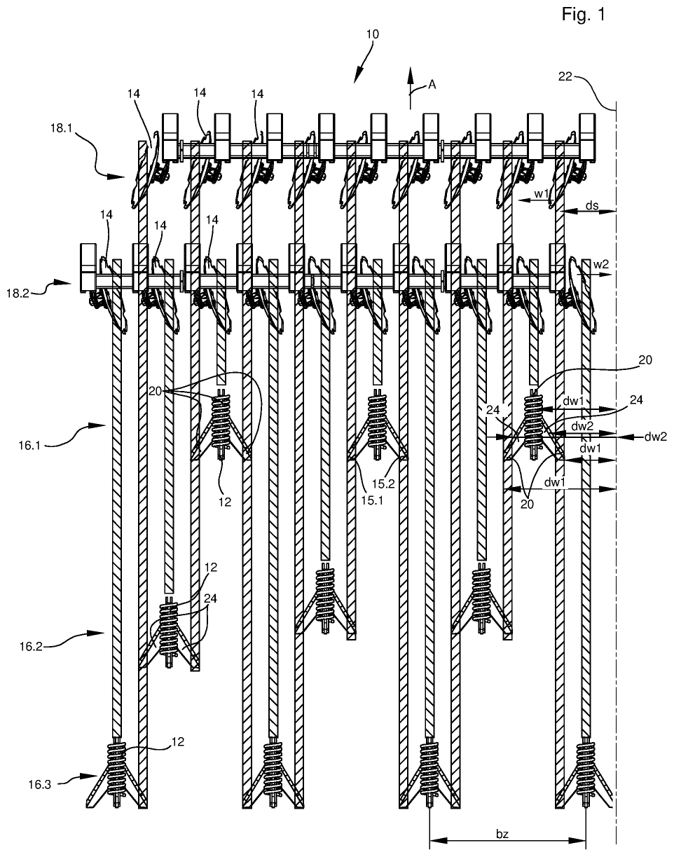

FIG. 1 shows a schematic plan view of an arrangement of soil tillage tools and disc tools according to a preferred embodiment.

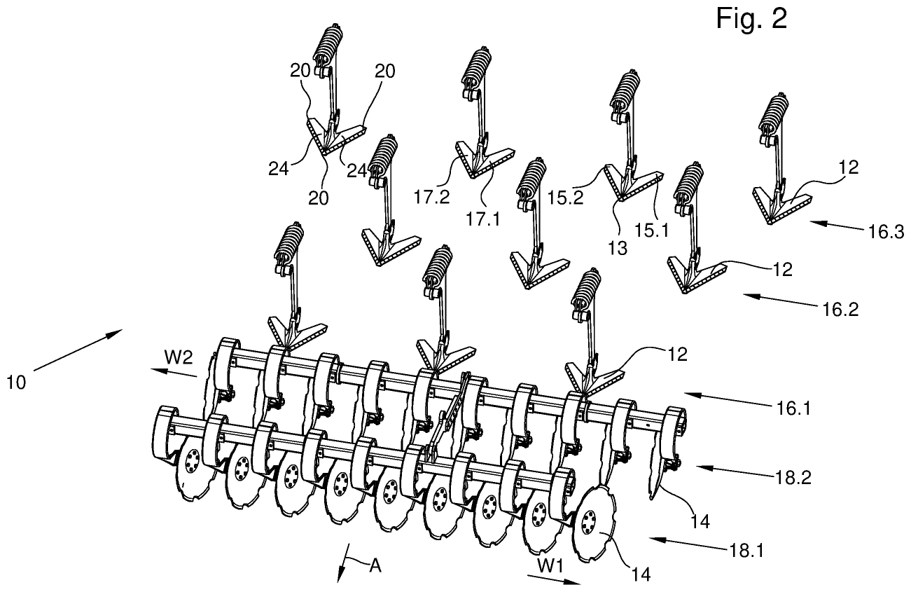

FIG. 2 shows a schematic perspective representation of the arrangement from FIG. 1.

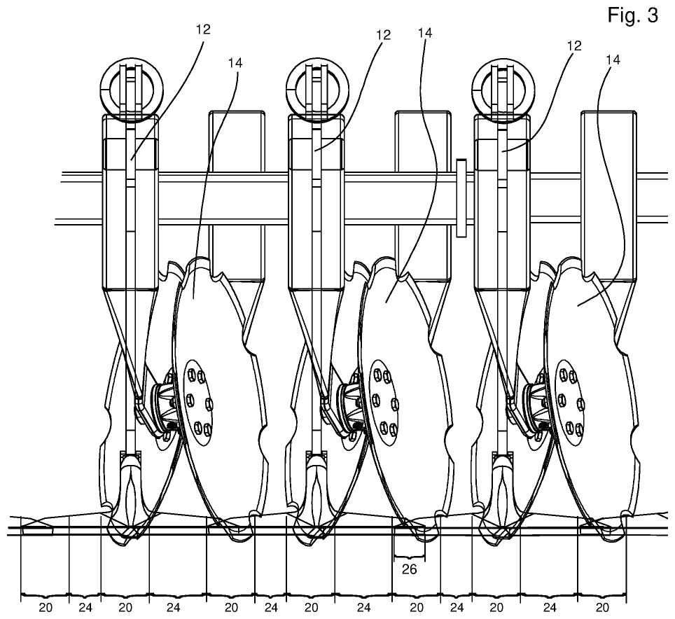

FIG. 3 shows a schematic front view of a preferred embodiment in which the elements lying aligned one behind the other are noticeable.

In the following description, same reference numbers are used for same or corresponding elements and a repetitive description is largely avoided.

FIG. 1 shows a schematic plan view of an arrangement of wing share cultivator tines 12 and hollow discs 14 according to a preferred embodiment of a wing share cultivator 10. The wing share cultivator tines 12 each comprise a first tool region which, in the shown embodiment, is located at the share tip 13 (see FIG. 2) of the wing share cultivator tine 12 and at the wing ends 15.1, 15.2 of the same. The first tool region 20 is a region of the share at which the same is subjected to greater wear than in a second tool region 24, which in the present example extends between the share tip 13 of the wing share cultivator tine 12 and the wing ends 15.1, 15.2 of the same and in the present context is referred to as wing 17.1, 17.2 (see FIG. 2).

The wing share cultivator tines 12 in the shown arrangement are arranged in three tool rows 16.1, 16.2, 16.3. From a wing share cultivator tine 12 arranged in a rear tool row 16.3 a wing share cultivator tine 12 of the tool row 16.2 located in the working direction A in front thereof lies displaced by a third of the mutual tine spacing bz between adjacent wing share cultivator tines 12 of the rear tool row 16.3 to the inside towards a centre longitudinal axis 22 of the wing share cultivator 10. This relative arrangement of wing share cultivator tines 12 also exists between the wing share cultivator tines 12 of the middle tool row 16.2 and the front tool row 16.1.

For each wing share cultivator tine 12, an individual first tool distance dw1 or an individual second tool distance dw2, each to the centre longitudinal axis 22 can be determined for each of its regions, namely the first tool region 20 and the second tool region 24. In the embodiment shown in FIG. 1, a small first tool distance dw1, a slightly greater second tool distance dw2, an even slightly greater further first tool distance dw1, an even slightly greater further second tool distance dw2 and an even slightly greater further first tool distance dw1 is noticeable on a selected wing share cultivator tine 12. In other words, the two wing ends 15.1, 15.2 form the smallest and the greatest first tool distance dw1, the share tip 13 of the wing share cultivator tine 12 forms the middle first tool distance dw1 and between these first tool distances dw1, second tool distances dw2 each are defined by the wings 17.1, 17.2 of the wing share cultivator tines 12 subjected to less severe wear.

In the working direction A in front of the wing share cultivator tines 12, multiple hollow discs 14 are positioned in disc rows 18.1, 18.2 that are arranged one behind the other in the working direction A and running transversely to the working direction A. However, in contrast with the prior art, the hollow discs in this preferred embodiment are arranged so that they, more precisely their cutting region engaging in the soil, are always positioned accurately aligned in front of one of the first tool regions 20 of the wing share cultivator tines 12. In other words, a lateral disc distance ds of at least one of the hollow discs 14 to the centre longitudinal axis 22 is equal, for each first tool region 20 of each of the wing share cultivator tines 12, to the corresponding first tool distance dw1.

Thus, the wear of the share tip 13 or of the wing end 15.1, 15.2 of the wing share cultivator tines 12 is reduced. Furthermore, the pulling-in behaviour of the shares 12, in particular in the case of shallow cutting angles or clearance angles is improved in this manner in that the soil already lies in front by way of the hollow discs 14.

For this purpose, the hollow discs 14 each define a throwing direction W1, W2, wherein the hollow discs 14 of the front disc row 18.1 define a first throwing direction W1 away from the centre longitudinal axis 22 and the hollow discs 14 of the rear disc row 18.2 a second throwing direction W2 towards the centre longitudinal axis 22.

FIG. 2 shows a schematic perspective representation of the arrangement from FIG. 1, wherein the reference numbers mark same elements. In this representation, the individual regions of the wing share 12 are better noticeable than in FIG. 1. In particular, the share tip 13 in this representation is better noticeable than in FIG. 1. The share tip 13 is followed on both sides by the wings 17.1, 17.2 each of which terminate in a wing end 15.1, 15.2.

FIG. 3 shows a schematic front view of a preferred embodiment, in which the elements located aligned one behind the other are noticeable. Here, the first tool regions 20 and second tool regions 24 should be emphasised in particular which, adjoining, lie next to one another. An overlap region 26 of two first tool regions 20, namely of the wing ends of two different wing share cultivator tines 12 is particularly clearly noticeable in this view. One of the hollow discs 14 lies in front of the overlap region and is thus jointly assigned to one of the first tool regions 20 of the two wing share cultivator tines 12.

### BEZUGSZEICHENLISTE

10 Wing share cultivator
12 Wing share cultivator tine
13 Share tip
14 Hollow disc
15.1, 15.2 Wing end
16.1 . . . 16.3 Tool row
17.1, 17.2 Wings
18.1, 18.2 Disc row
20 First tool region
22 Centre longitudinal axis
24 Second tool region
26 Overlap region
bz Tine spacing
ds Disc distance
dw1 First tool distance
dw2 Second tool distance
A Working direction
W1 First throwing direction

1. A soil tillage implement (10) having a number n of soil tillage tools (12), in particular tine-type tools such as wing share cultivator tines or goosefoot share cultivator tines,
wherein the soil tillage tools (12) are arranged in one or multiple tool rows (16.1 . . . 16.3) following one another in the working direction (A) and oriented transversely to the working direction (A),
wherein the soil tillage tools (12) comprise at least a first tool region (20) and a second tool region (24) and wherein the first tool region (20), through its exposed arrangement, is subjected to greater wear than the second tool region (24),
wherein the soil tillage implement (10) furthermore comprises a numbers of disc tools (14), which are arranged in one or more disc rows (18.1, 18.2) following one another in the working direction (A) and oriented transversely to the working direction (A) which lie in the working direction (A) in front of the soil tillage tools (12),
wherein each of the disc tools (14) has an individual lateral disc distance (ds) from a centre longitudinal axis (22) of the soil tillage implement (10),
wherein the first tool region (20) of each of the soil tillage tools (12) has an individual first lateral tool distance (dw1) and the second tool region (24) of each of the soil tillage tools (12) has an individual second lateral tool distance (dw2) from the centre longitudinal axis (22) of the soil tillage implement (10), which deviates from the individual first tool distance (dw1), characterised in that
the disc tools (14) and the soil tillage tools (12) are arranged in such a manner that each first tool region (20) with the first lateral tool distance (dw1) is assigned a disc tool (14) with the lateral disc distance (ds) in such a manner that the first lateral tool distance (dw1) is equal to the lateral disc distance (ds).

2. The soil tillage implement (10) having soil tillage tools (12), in particular tine-type tools such as wing share cultivator tines or goosefoot share cultivator tines, and a centre longitudinal axis (22),
wherein the soil tillage implement (10) comprises a number n of soil tillage tools (12), which are arranged in one or multiple tool rows (16.1 . . . 16.3) following one another in the working direction (A) and oriented transversely to the working direction (A), and
comprises a number s of disc tools (14) which are arranged in one or more disc rows (18.1, 18.2) following one another in the working direction (A) that are oriented transversely to the working direction (A) and are located in the working direction (A) in front of the soil tillage tools (12),
wherein the soil tillage tools (12) comprise at least a first tool region (20) and a second tool region (24) and wherein the first tool region (20), by way of its exposed arrangement, is subjected to greater wear than the second tool region (24), characterised in that the disc tools (14) and the soil tillage tools (12) are arranged in such a manner that each first tool region (20) is assigned a disc tool (14) in such a manner that the first tool region (20) is arranged aligned in the working direction (A) behind the disc tool (14).

3. The soil tillage implement (10) according to claim 1,
wherein the soil tillage tools (12) are wing share cultivator tines or goosefoot share cultivator tines, which comprise a share tip (13) and two wings each with a wing end (15.1, 15.2), wherein the share tip (13) and the two wing ends (15.1, 15.2) form the first tool region (20) and the wings (17.1, 17.2) form the second tool region (24).

4. The soil tillage implement (10) according to claim 1, wherein the soil tillage tools (12) partly overlap one another in the working direction (A), wherein in particular the wing ends (15.1, 15.2) of the wing share cultivator tines or goosefoot share cultivator tines overlap one another in the working direction (A), and
wherein the overlap region, in which the soil tillage tools (12) overlap one another in the working direction (A), is part of the first tool region (20).

5. The soil tillage implement (10) according to claim 1, wherein the soil tillage tools (12) each comprise a share tip (13), which forms at least a part of the first tool region (20),
wherein the number s of the disc tools (14) is equal to the number n of the soil tillage tools (12).

6. The soil tillage implement (10) according to claim 1,
wherein the soil tillage tools (12) each comprise one or two wing share ends (15.1, 15.2), which forms or form at least a part of the first tool region (20),
wherein the number s of the disc tools (14) in each case is greater or smaller by one than the number n of the soil tillage tools (12).

7. The soil tillage implement (10) according to claim 1,
wherein the number s of the disc tools (14) in each case is greater or smaller by one than twice the number n of the soil tillage tools (12).

8. The soil tillage implement (10) according to claim 1,
wherein the respective outermost disc tools (14) and the directly adjacent disc tools (14) have a throwing direction (W2) directed to the inside towards the centre longitudinal axis (22).

9. The soil tillage implement (10) according to claim 1,
wherein the soil tillage implement (10) comprises a frame in order to arrange the soil tillage tools (12) over a frame area, and a running gear having at least one main wheel, wherein the running gear is arranged within the frame area in such a manner that with respect to the working direction (A) in front of an preferably behind the running gear as well as to the left and right of the running gear at least one soil tillage tool (12) is arranged.

10. The soil tillage implement (10) according to claim 1,
wherein the disc tools (14) are hollow discs, by way of which a throwing direction (W1, W2) each is defined,
wherein the throwing directions (W1, W2) of hollow discs (14) lying in the working direction (A) one behind the other are opposite to one another.

11. The soil tillage implement (10) according to claim 1,
wherein on both sides outside the centre longitudinal axis (22) the same number of disc tools (14) per row are arranged.

12. The soil tillage implement (10) according to claim 9,
wherein some soil tillage tools (12) are arranged on a middle frame segment and of these two or more soil tillage tools (12) form a tool row (16.1) located furthest in the working direction (A) in front of the running gear and,
wherein preferably in each case a plurality of soil tillage tools (12) is arranged on a left lateral frame segment and a right lateral frame segment,
wherein the lateral frame segments are each foldable relative to the middle frame segment about a folding axis running parallel to the working direction in order to switch the soil tillage implement (10) between a working position and a transport position,
wherein preferably the running gear is arranged on the middle frame segment and wherein optionally support wheels are arranged on the lateral frame segments.

13. A method for producing a soil tillage implement (10) according to claim 1,
characterised in that
the disc tools (14) and the soil tillage tools (12) are arranged in such a manner that each first tool region (20) with the first lateral tool distance (dw1) a disc tool (14) with the lateral disc distance (ds) is assigned in such a manner that the first lateral tool distance (dw1) is equal to the lateral disc distance (ds).

14. The method for producing a soil tillage implement (10) according to claim 7,
characterised in that
the disc tools (14) and the soil tillage tools (12) are arranged in such a manner that each first tool region (20) is assigned a disc tool (14) in such a manner that the first tool region (20) is arranged aligned in the working direction (A) behind the disc tool (14).
